(19) United States
(12) Patent Application Publication
(10) Pub. No.: US 2016/0246789 A1
(43) Pub. Date: Aug. 25, 2016

(54) SEARCHING CONTENT OF PROMINENT USERS IN SOCIAL NETWORKS

(71) Applicant: Google Inc., (US)

(72) Inventors: Yihua Wu, Princeton Junction, NJ (US); Kumar Mayur Thakur, West Orange, NJ (US); Jeremy Hylton, Easton, PA (US); David Weissman, Union City, NJ (US)

(73) Assignee: Google Inc., Mountain View, CA (US)

(21) Appl. No.: 13/788,148

(22) Filed: Mar. 7, 2013

Related U.S. Application Data
(60) Provisional application No. 61/638,322, filed on Apr. 25, 2012.

(51) Int. Cl. G06F 17/30

(52) U.S. Cl. CPC G06F 17/3053

(57) ABSTRACT

Methods, systems, and apparatus, including computer programs encoded on computer storage medium, for receiving a query; retrieving one or more social restricts associated with the user, the one or more social restricts comprising a set of author-based query restricts; generating an augmented query based on the query and the set of author-based query restricts; obtaining a set of social search results that are responsive to the augmented query, each social search result in a first sub-set of the set of social search results being associated with an author-based document restrict that corresponds to an author-based query restrict in the set of author-based query restricts; and providing the social search results for display to the user.

### CROSS-REFERENCE TO RELATED APPLICATIONS

This application claims the benefit of U.S. Provisional Application No. 61/638,322, filed on Apr. 25, 2012, the disclosure of which is expressly incorporated herein by reference in its entirety.

### BACKGROUND

The present disclosure relates to searching.

Search engines aim to identify resources (e.g., images, audio, video, web pages, text, documents) that are relevant to a user's needs and to present information about the resources in a manner that is most useful to the user. Search engines return a set of search results in response to a user submitted text query. For example, in response to a search query, the search engine returns a set of search results identifying resources responsive to the search query.

Search results can include social search results. Social search results can include digital content that is distributed by a user through one or more computer-implemented services to an audience of other users of the one or more computer-implemented services. In some instances, relevant social search results might not be discoverable to searching users.

### SUMMARY

This specification describes technologies relating to searching.

In general, aspects of the subject matter described in this specification can be embodied in methods that include the actions of receiving a query, retrieving one or more social restricts associated with the user, the one or more social restricts including a set of author-based query restricts, generating an augmented query based on the query and the set of author-based query restricts, obtaining a set of social search results that are responsive to the augmented query, each social search result in a first sub-set of the set of social search results being associated with an author-based document restrict that corresponds to an author-based query restrict in the set of author-based query restricts, and providing the social search results for display to the user. Other implementations of this aspect include corresponding systems, apparatus, and computer program products.

These and other implementations can optionally include one or more of the following features: actions further include: identifying one or more prominent users that the user is connected to in one or more computer-implemented services, and for each of the one or more prominent users, adding a respective author-based query restrict to the set of author-based query restricts; actions further include: identifying a plurality of prominent users that the user is connected to in one or more computer-implemented services, determining that a number of prominent users in the plurality of prominent users exceeds a threshold number, selecting a set of prominent users from the plurality of users, and for each of the one or more prominent users in the set of prominent users, adding a respective author-based query restrict to the set of author-based query restricts; selecting a set of prominent users from the plurality of users includes receiving a plurality of scores, each score being associated with a respective prominent user in the plurality of prominent users, each prominent user in the set of prominent users being selected for inclusion in the set of prominent users based on the score; the score includes a prominence score that reflects a relative prominence of a respective prominent user within the one or more computer-implemented services; the score is based on a number of followers of the respective prominent user within the one or more computer-implemented services; actions further include identifying an author user as a prominent user within one or more computer-implemented services; the author-based document restrict is associated with the prominent user; the prominent user published a resource using the one or more computer-implemented services, the resource being associated with a social search result in the social search results; identifying an author user as a prominent user includes determining that the author user has at least a threshold number of relationships with other users in the one or more computer-implemented services; the relationships include asymmetric relationships; each social search result in a second sub-set of the set of social search results being associated with a user-based document restrict that corresponds to a user-based query restrict; the user-based query restrict is specific to the user; the user-based document restrict reflects that an author user distributed a resource associated with a respective social search result to the user using one or more computer-implemented services; the one or more social restricts further comprise a user-based query restrict, the user-based query restrict being user to identify resources distributed to the user in one or more computer-implemented services; and the one or more social restricts are associated with a social graph of the user, the social graph reflecting relationships between the user and other users of one or more computer-implemented services.

Particular implementations of the present disclosure can be implemented to realize one or more of the following advantages. For example, improved coverage in social search results can be provided by improved searching of resources using author-based query restricts. As another example, a better balance is provided between a size of an index of resources to be searched and a search latency. For example, the number of document restricts provided in the index of resources can be reduced as a result of the author-based query restricts. The details of one or more implementations of the present disclosure are set forth in the accompanying drawings and the description below. Other features, aspects, and advantages of the present disclosure will become apparent from the description, the drawings, and the claims.

### BRIEF DESCRIPTION OF THE DRAWINGS

FIG. 1 depicts an example information retrieval system.

FIG. 2 is a diagram of example sources of social graph information.

FIG. 3 is a flow diagram of an example method for using social graph information.

FIG. 4 is a flow diagram of an example method for presenting search results including social graph information.

FIG. 5 is a representation of an example search results page including search results associated with the user's social graph.

FIG. 6 depicts an example social graph portion.

Like reference numbers and designations in the various drawings indicate like elements.

### DETAILED DESCRIPTION

Aspects of this specification are directed to increasing the discoverability of resources as potential social search results. More particularly, implementations of the present disclosure are directed to enhancing serving of resources that are published by prominent users using one or more computer-implemented services. In some examples, author-based document restricts are associated with resources that are indexed for searching. Each author-based restrict can indicate that a particular user published a particular resource. Implementations of the present disclosure are further directed to augmenting queries submitted by searching users to discover resources that are published by prominent users. In some examples, one or more author-based query restricts are appended to a query submitted by a user, the one or more author-based query restricts being associated with respective prominent users that the user follows in the one or more computer-implemented services. During search, a resource can be identified as a potential social search result when an author-based document restrict associated with the resource matches an author-based query restrict appended to the query.

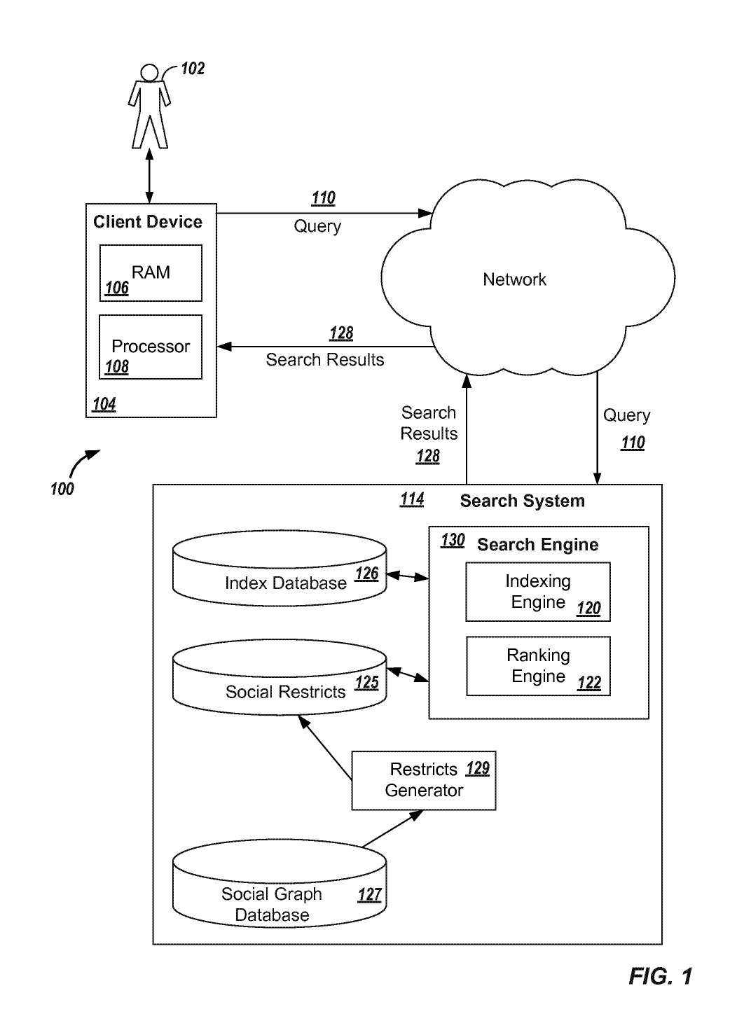

FIG. 1 depicts an example information retrieval system 100. The system 100 provides search results relevant to submitted queries as can be implemented in the Internet, an intranet, or another client and server environment. In accordance with the present disclosure, and as discussed in further detail herein, the system 100 also provides social search results in response to the submitted queries. The system 100 is an example of an information retrieval system in which the systems, components, and techniques described below can be implemented.

A user 102 can interact with a search system 114 through a client device 104. For example, the client device 104 can be a computing device coupled to the search system 114 through a local area network (LAN) or wide area network (WAN), e.g., the Internet. In some implementations, the search system 114 and the client device 104 can be one machine. For example, a user can install a desktop search application on the client device 104. The client device 104 will generally include a random access memory (RAM) 106 and a processor 108.

The client device 104 can include any type of computing device such as a desktop computer, a tablet computer, a laptop computer, a handheld computer, a personal digital assistant (PDA), a cellular telephone, a network appliance, a camera, a smart phone, an enhanced general packet radio service (EGPRS) mobile phone, a media player, a navigation device, an electronic messaging device, a game console, or a combination of any two or more of these data processing devices or other appropriate data processing devices. In some examples, the search system 114 can include one or more server systems.

A user 102 can submit a query 110 to the search system 114. When the user 102 submits a query 110, the query 110 is transmitted through a network to the search system 114. The search system 114 can be implemented as, for example, one or more computer programs running on one or more computers (e.g., servers) in one or more locations that are coupled to each other through a network. In some implementations, the search system 114 includes a social restricts database 125, an index database 126, a social graph database 127, a restricts generator 129 and a search engine 130. In some examples, the search engine 130 includes an indexing engine 120 and a ranking engine 122. The search system 114 responds to the query 110 by generating search results 128, which are transmitted through the network to the client device 104 in a form that can be presented to the user 102 (e.g., as a search results web page to be displayed in a web browser running on the client device 104). In some implementations, the search system 114 can further respond to the query 110 by identifying social search results.

In some implementations, the social restricts database 125 stores one or more social restricts that can be associated with resources, as so-called document restricts, and one or more social restricts that can be appended to received queries, as so-called query restricts. In some implementations, restricts can be used to enforce access control to digital content, and to determine digital content that can be returned in response to a search query. In some examples, document restricts can include author-based document restricts and user-based document restricts. In some examples, query restricts can include author-based query restricts and user-based query restricts. In some implementations, the restricts generator 129 generates the one or more social restricts based on social graph information provided from the social graph database 127. In some examples, the one or more social restricts are generated on a per user basis (e.g., are user-specific) based on a user-specific social graph. Social restricts and social graphs are discussed in further detail below.

When the query 110 is received by the search engine 130, the search engine 130 can append one or more query restricts to the query to provide an augmented query. In some examples, another component (not shown) can append the one or more query restricts to the query and can provide the augmented query to the search engine 130. In some implementations, the one or more query restricts are particular to the user (e.g., the user 102) that submitted the query 110. In some examples, the user 102 can be logged into a computer-implemented search service that is provided by the search system 114, and the user 102 can be identified based on the log-in information. In some examples, the one or more query restricts can be retrieved from the social restricts database 125 based on an identifier associated with the user 102.

The search engine 130 identifies resources that match, or are responsive to the augmented query. In some examples, resources can include one or more network-accessible documents (e.g., web pages) and/or files. In some examples, resources can include digital content that is distributed by users of one or more social networking services. In some examples, identified resources include resources that are responsive to the original query and that are filtered based on the one or more query restricts. For example, a resource can be associated with a particular document restrict. The resource can be determined to be responsive to the query and the particular document restrict can match a query restrict provided in the augmented query. Consequently, the resource can be provided as a social search result in response to submission of the original query. In some examples, a document restrict and a query restrict can be deemed to match if one or more strings provided in the document restricts are the same as one or more strings in a query restrict. For example, a document restrict can include an alpha-numeric string associated with an identifier of a user. The document restrict can be determined to match a query restrict, if the query restrict includes the same alpha-numeric string.

In the depicted example, the indexing engine 120 indexes resources (e.g., social networking content, web pages, images, or news articles on the Internet) found in a collection of content and the index database 126 stores the index information. The ranking engine 122 (or other software) is operable to rank resources that match the query 110, such that search results can be displayed in a rank order. The indexing and ranking of the resources can be performed using conventional or other techniques. The search system 114 can transmit the search results 128 through the network to the client device 104 for presentation to the user 102.

In some implementations, and as discussed above, search results can include social search results. In some examples, the social search results can include digital content that is distributed by users (author users) of one or more social networking services. In some examples, the author users can be connected to the searching user (e.g., the user 102 of FIG. 1) through the one or more social networking services. In some examples, and as discussed in further detail herein, relationships between users can be described with reference to a social graph.

As used in this specification, a social graph can refer to a single social graph or multiple interconnected social graphs. Distinct social graphs can be generated for different types of connections a user has. For example, a user can be connected with chat contacts in one social graph, electronic messaging contacts in a second social graph, and connections (or contacts) from a particular social networking service in a third social graph. Each social graph can include edges to additional individuals or entities at higher degrees of separation from the user. These contacts can in turn have additional contacts at another degree of separation from the user. Similarly, a user's connection to someone in a particular social network can then be used to identify additional connections based on that person's connections. The distinct social graphs can include edges connecting one or more social graphs to one or more other social graphs.

Types of connections and social graphs can include, but are not limited to other users in which the user is in direct contact (e.g., user mail or chat contact, direct contacts on social sites) and users in which the user is in indirect contact (e.g., contacts of contacts). In some implementations, the social graph includes content generated by individuals (e.g., social networking posts, blog posts, reviews) as connections to the user. The social graph can include connections within a single network or across multiple networks (separable or integrated). Public social graph relationships can also be considered. In some examples, public relationships can be established through public profiles and/or public social networking services.

In some examples, a social graph can be depicted as a graph using nodes and edges between nodes. Each node can represent a user of one or more computer-implemented services (e.g., a social networking service, a micro-blogging service, a blogging service, a document sharing service, an image sharing service, a video sharing service) and each edge can represent a relationship between nodes. In some examples, a unidirectional edge can represent an asymmetric relationship between users. In some examples, a bidirectional edge can represent a symmetric relationship between users. Asymmetric and symmetric relationships are discussed in further detail below.

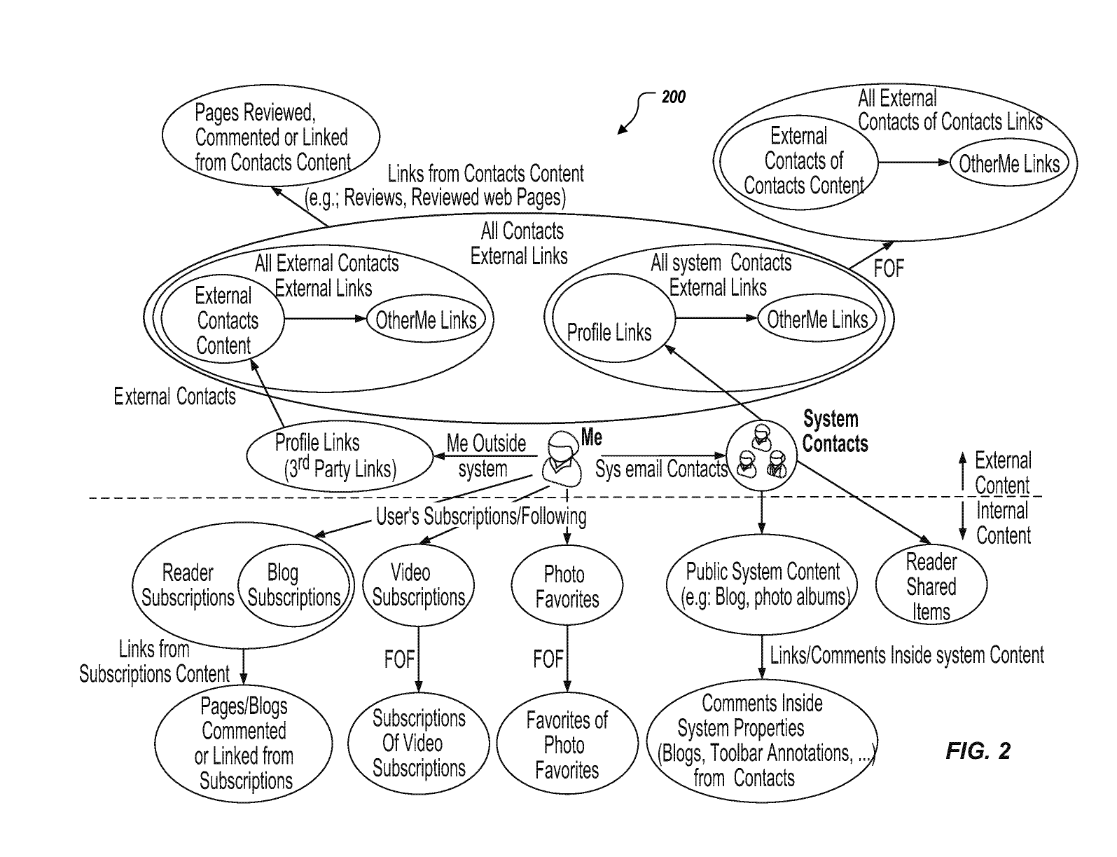

FIG. 2 is a diagram 200 of example sources of social graph information. The user's social graph is a collection of connections (e.g., users, resources) identified as having a relationship to the user within a specified degree of separation. The user's social graph can include people and particular content at different degrees of separation. For example, the social graph of a user can include contacts, contacts of contacts (e.g., as defined by a user, social graphing site, or other metric), the user's social circle, people followed by the user (e.g., subscribed blogs, feeds, or web sites), and other specifically identified content of interest to the user (e.g., particular web sites).

Diagram 200 shows a user (e.g., the user 102 of FIG. 1) and example connections that extend a user's social graph to people and content both within a system and across one or more external networks and shown at different degrees of separation. For example, a user can have a profile or contacts list that includes a set of identified contacts, a set of links to external resources (e.g., web pages), and subscriptions to content of the system (e.g., a system that provides various content and applications including electronic messaging, chat, video, photo albums, feeds, or blogs). Each of these groups can be connected to other users or resources at another degree of separation from the user. For example, the contacts of the user each have their own profile that includes links to resources as well as contacts of the respective contacts. The connections to a user within a specified number of degrees of separation can be considered the social graph of the user. In some implementations, the number of degrees of separation used in determining the user's social graph can be specified by the user. In some implementations, a default number of degrees of separation is used. Moreover, a dynamic number of degrees of separation can be used that is based on, for example, the type of connection.

In some implementations, the membership and degree of separation in the social graph is based on other factors, including a frequency of interaction. For example, a frequency of interaction by the user (e.g., how often the user visits a particular social graphing site) or type of interaction (e.g., endorsing or selecting items associated with friends). In some examples, respective weights can be associated with nodes and/or edges, and a degree of separation between users can be determined based on the weights. As interaction changes, the relationship of a particular contact, node weights and/or edge weights in the social graph can also dynamically change. Thus, the social graph can be dynamic rather than static.

In some implementations, social signals can be layered over the social graph (e.g., using weighted edges or other weights between connections in the social graph). These signals, for example, frequency of interaction or type of interaction between the user and a particular connection, can then be used to weight particular connections in the social graph or social graphs without modifying the actual social graph connections. These weights can change as the interaction with the user changes.

In some examples, a relationship between the user and a contact within a computer-implemented service can be provided as a symmetrical relationship. In some examples, a symmetrical relationship enables some non-public digital content published by or associated with the user to be accessible to the contact, as designated to be accessible to the contact by the user; and conversely, non-public digital content published by or associated with the contact to be accessible to the user, as designated to be accessible to the user by the contact. In some examples, the relationship between the user and the contact can be provided as an asymmetrical relationship. In some examples, an asymmetrical relationship enables some non-public digital content published by or associated with the user to be inaccessible to the contact, as designated by the user, while some digital content published by or associated with the contact to be accessible to the user, as designated by the contact. In some examples, the digital content published by or associated with the contact and accessible to the user can include non-public content designated by the contact. In some examples, the digital content published by or associated with the contact and accessible to the user can include public content designated by the user. In some implementations, computer-implemented services can provide an asymmetrical relationship between the user and the contact such that the social networking service can selectively provide access to the digital content associated with the user and shared via the computer-implemented service, as designated by the user and/or the contact.

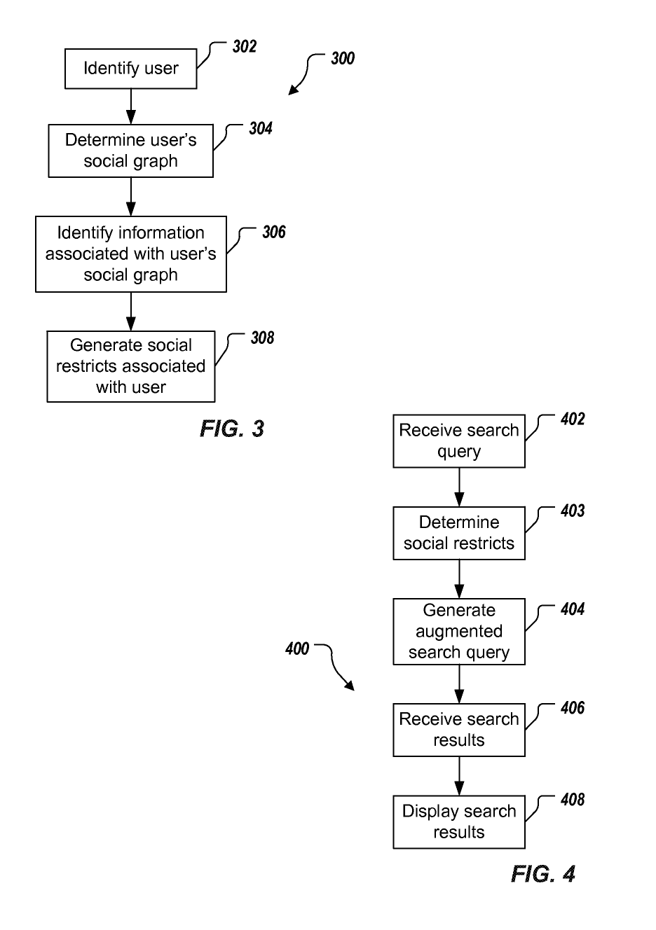

FIG. 3 is a flow diagram of an example method 300 for using social graph information. For convenience, the method 300 will be described with respect to a system, including one or more computing devices, that performs the method 300.

The system identifies a user (302). The user can be identified, for example, based on a user profile associated with the system. The user profile can be identified, for example, when the user logs into the system using a username, electronic messaging address, or other identifier.

The system determines the user's social graph (304). The user's social graph identifies people and resources associated with the user, for example, in which the user has indicated an interest. In some implementations, the social graph is limited to a specified number of degrees of separation from the user or particular relationships or types of interaction with the user. In some implementations, the user's social graph is generated by another system and provided upon request. In some examples, the user's social graph can be provided as an index that identifies each member of the user's social graph and indicates one or more services, through which the user and the member are connected (e.g., electronic messaging contacts, social networking contacts, etc.).

In some implementations, the user's social graph is determined using user profile data, as well as extracting information from users and resources identified in the user profile data. For example, the user's profile can include a list of the user's contacts. The user's contacts can include contacts within the system (e.g., using a same electronic messaging or chat service that is affiliated with the system) or external to the system (e.g., social graphs or a list of contacts associated with third party applications or service providers). The user's profile can also include a list of subscriptions to which the user belongs (e.g., identifying content that the user follows, for example, particular blogs or feeds).

The user's profile can also include external links identified by the user. These links can identify particular content of interest. In some implementations, the user's profile also identifies other aliases used by the user (e.g., as associated with particular content providers or social graph sources). For example, a user may have a first identity for a chat application and a second identity for a restaurant review web site. These two identities can be linked together in order to unify the content associated with that user.

The social graph can be further expanded by determining information from the identified people and content in the user's profile. For example, public profile information can exist for identified contacts, from which information can be determined (e.g., their contacts, links, and subscriptions). In some implementations, the user can adjust the members of the social graph directly. For example, the user can group their contacts (e.g., electronic messaging contacts) into particular groups accessed by the system in building the user's social graph.

In some implementations, the system may allow a user to prevent the system from adding members to the user's social graph, for example, through user preference settings, e.g., including a preference to keep contacts out of the particular groups used by the system to generate the social graph. In some implementations, privacy features may provide a user with an opt-in or opt-out option to allow or prevent, respectively, being included (or remove the user if already included) as a member of another's social graph.

The system identifies information associated with the user's social graph (306). Identified content associated with the user's social graph can include, for example, content or posting to resources subscribed to by the user (e.g., particular blogs). The identified information can also include content generated by members of the user's social graph. For example, members of a user's social graph can generate content including, for example, local reviews (e.g., for restaurants or services), video reviews and ratings, product reviews, book reviews, blog comments, news comments, maps, public web annotations, public documents, streaming updates, photos and photo albums. Thus, the content can include both content generated by the members of the user's social graph, as well as content endorsed or reviewed by the members of the user's social graph.

One or more social restricts associated with the user are generated (308). The one or more social restricts are generated based on the social graph information associated with the user. The one or more social restricts are stored for use in information retrieval (e.g., retrieving one or more resources as search results). For example, an index can be searched in response to a received search query to identify relevant search results associated with members of the user's social graph based on the one or more social restricts. As another example, resources generated by the user can be indexed and can be associated with one or more social restricts to enable the resources to be identified as search results in response to a search query. In some implementations, the indexed social graph information is periodically updated, for example, to include recently added information associated with the user's social graph. Consequently, the one or more social restricts associated with the user can also be periodically updated.

FIG. 4 is a flow diagram of an example method 400 for presenting search results including social graph information. For convenience, the method 400 will be described with respect to a system including one or more computing devices that performs the method 400.

The system receives a search query from a user (402). For example, the user can input a search query into a search interface of a particular search system. The search query includes one or more terms and can be general or directed to particular types of resources (e.g., a web search or an image search).

The user can submit the search query from a client device. The client can be a computer coupled to the search system through a local area network (LAN) or wide area network (WAN), e.g., the Internet. In some implementations, the search system and the client device is a single machine. For example, a user can install a desktop search application on the client device. The user can submit the search query to a search engine within the search system. When the user submits the search query, the search query is transmitted through a network to the search system. The search system can be implemented as, for example, computer programs running on one or more computers in one or more locations that are coupled to each other through a network.

One or more social restricts are determined (403). In some examples, the one or more social restricts are determined based on a subset of prominent users, as discussed in further detail below. In some examples, each social restrict is associated with a prominent user in the subset of prominent users. The one or more social restricts are appended to the search query to generate an augmented query (404). In some examples, the one or more query restricts are particular to the user that submitted the search query. In some examples, the user can be logged into a computer-implemented search service and the user can be identified based on the log-in information. In some examples, an identity of the user within the computer-implemented search service is needed in order to generate the augmented query and to determine which query restricts are used to generate the augmented query. For example, if the user is not logged into the search service, an augmented query is not generated.

The system receives search results including search results associated with the user's social graph (406). For example, the search engine identifies resources that are responsive to the query and/or the augmented query using an index and one or more social restricts associated with resources in the index. The search engine will generally include an indexing engine that indexes resources (e.g., web pages, images, or news articles on the Internet) found in a corpus (e.g., a collection or repository of content), an index database that stores the index information, and a ranking engine (or other software) to rank the resources that match the query. The indexing and ranking of the resources can be performed using conventional or other techniques. The social graph information can be included in the same index as other resources or in a separate index. Consequently, a separate search can be performed for general search results responsive to the query, as well as particular search results that identify resources associated with the user's social graph based on the augmented query.

In some implementations, the presentation and ranking of search results associated with the user's social graph is adjusted by one or more factors including one or more social signals. For example, affinity can be used to determine whether to show content from a particular member of the user's social graph or whether to promote or demote the member's ranking. Affinity identifies the closeness of a member to the user. For example, a friend of a friend who has five common middle friends with the user has a higher affinity than a friend of a friend who has only one common middle friend. Other factors in determining affinity can include: how a friend is connected to the user (e.g., the source of the connection), which social graphing site the friend is a member of, whether friend or friend of friend, and how many paths to get to the friend of a friend (e.g., common middle friends).

Affinity can also be based on the user's interactions with members of the social graph (e.g., frequency, type). For example, a user that frequently clicks on posts by a particular contact can have a higher affinity with that contact than the affinity with other contacts where they click on respective posts less frequently. Affinity can also be greater for particular types of interactions, for example, comments on contact's posts can result in higher affinity than occasional endorsements. Affinity can change over time. For example, as the types or frequency of interactions change with members of the social graph, the resulting affinity can change as well.

Ranking can also be effected based on other factors, for example, an information retrieval score of social graph content relative to the submitted query (e.g., relevance of the social graph content), content type (e.g., blogs versus images), and the date of the associated content.

Additionally, when interleaving search results associated with the user's social graph along with general search results, a promotion can be applied to the search results associated with the user's social graph in order to increase their visibility. For example, the ranking of search results associated with the user's friends is often lower than a general wide-spread result. Thus, promotion of search results associated with the user's social graph can prevent them from being buried by general search results.

Interactions performed by members of the user's social graph can be used as social signals to adjust rankings of corresponding search results. For example, if a search query identifies results that include a resource that has been so identified by a member of the user's social graph, this result can be boosted relative to other general search results responsive to the user's query. The boosting factor could be based on, for example, the number of friends who endorsed the identified resource or a top affinity to a friend who endorsed the identified resource. Boosting can also be based on authorship (e.g., what is the relationship or affinity with the individual that endorsed the resource), or the type of endorsement did the member of the user's social graph provide (e.g., an explicit endorsement by starring a result or page or an implicit endorsement by visiting the resource or commenting on a posting).

The system provides for presentation one or more of search results including search results from social graph (408). The search engine can transmit the search results through the network to the client device for presentation to the user e.g., as a search results web page to be displayed in a web browser running on the client device. In some implementations, the system clusters search results from the social graph by member of the social graph and presents the responsive results for that member together.

For example, the received search query can be “safari in Tanzania,” discussed further below. The system receives search results responsive to the query “safari in Tanzania.” This can include search results identifying, for example, various tour companies providing safaris in Tanzania. The search results can also include search results associated with the user social graph based on an augmented query (e.g., a prominent user's review of a particular safari provider or pictures by contacts from their safaris in Tanzania).

The search results can be presented in a number of different ways. The search results can be presented to the user, e.g., as a search results page, that includes one or more of the general search results and the search results associated with the user's social graph. The search results can be presented with separate portions displaying general search results and social graph results, respectively. Alternatively, relevant search results associated with the user's social graph can be interleaved with general search results. Additionally, the results whether displayed separately or interleaved, can be separated by type of content (e.g., web page listings, images).

The search results associated with the user's social graph can also be displayed according to content type (e.g., an image or web page) or clustered according to social graph member. In some implementations, when clustering the results from the social graph by member of the social graph, the content from each member having responsive content will be grouped together for presentation (e.g., the photos and review of friend one followed by the photos of friend two).

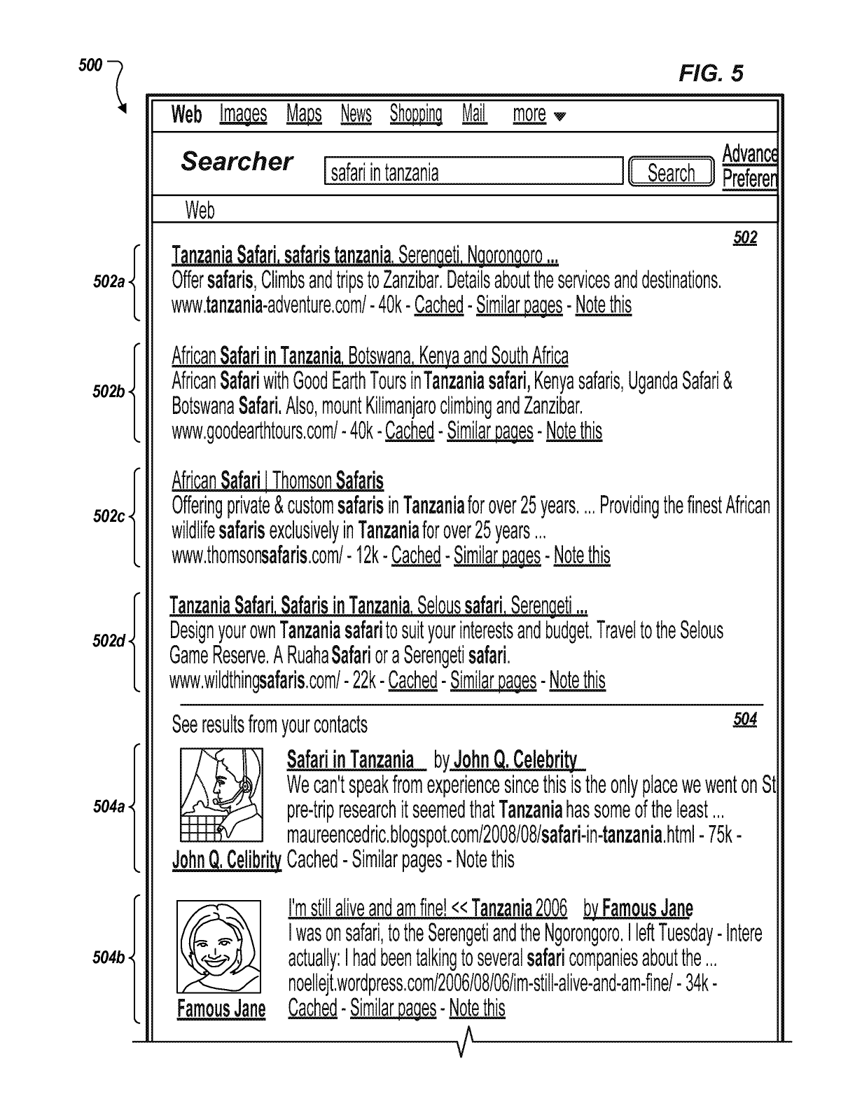

FIG. 5 is a representation of an example search results page 500 that includes results associated with the user's social graph. The search results page 500 displays example search results responsive to the example query “safari in Tanzania.” In the depicted example, the displayed search results include web results 502, as well as social results 504 based on the user's social graph. The web results 502 include search results 502a, 502b, 502c, 502d, and the social results 504 include search results 504a, 504b. The social results 504 includes responsive search results associated with a social graph of the user. For example, the results from the user's social graph 504 includes blog postings, video, and photos from people in the user's social graph. Additionally, in some implementations, a representation of the social graph contact is also presented with the search result (e.g., a picture and name of the contact). In the depicted example, the search results 504a, 504b are associated with resources distributed by respective prominent users. The search results 504a, 504b can be identified as responsive to the example query and as having a social connection to the user that submitted the example query based on author-based social restricts, as discussed in further detail herein.

In accordance with aspects of this specification, one or more author-based and/or one or more user-based document restricts can be associated with one or more resources generated by a user of one or more computer-implemented services. In some examples, an author user can author and/or publish digital content (e.g., a social networking post, a micro-blogging post, a blog post, a digital image, a digital video, an electronic document) using a computer-implemented service (e.g., a social networking service, a micro-blogging service, a blogging service, an image sharing service, a video sharing service, a document sharing service). The digital content (which can also be described as a resource) can be indexed and one or more document restricts can be associated therewith.

In accordance with implementations of the present disclosure, a resource generated by an author user can be indexed and can be associated with an author-based document restrict. In some examples, the author-based document restrict reflects that the author user authored the resource. By way of example, an author-based document restrict can include <authored by X>, where X is an identifier associated with the author user. In this manner, each resource can be associated with an author-based document restrict. In accordance with implementations of the present disclosure, a resource generated by the author user can be indexed and can be associated with one or more user-based document restricts. In some examples, a user-based document restrict reflects that the author user distributed the resource to a particular user (e.g., sent a social networking post to a particular user or a particular set of users). By way of example, a user-based document restrict can include <show to Y>, where Y is an identifier associated with a user, to which the resource is made available. In some examples, author-based document restricts are added to resources regardless of the category of user that the author user might be provided as (e.g., regular user, prominent user (discussed in further detail below)).

In some examples, one or more user-based document restricts are associated with the resource, if the resource is distributed by the author user to a private audience and/or an audience that includes less than a threshold number of users (e.g., follower users (discussed in further detail below) and/or symmetric contacts). For example, the resource can include a private post to a social networking service distributed to a number of users that is less than a threshold number of users and, in response, one or more user-based document restricts can be associated therewith.

In some implementations, categories of users can be provided and can include prominent users. In some examples, a user can be categorized as a prominent user based on a number of contacts that the user has within one or more computer-implemented services, a number of resources distributed by the user as an author user through one or more computer-implemented services, and/or traffic generated by the user within one or more computer-implemented services. In some examples, traffic can be determined based on a number of resources distributed by the author user and a number of follower users that follow the user within the one or more computer-implemented services (discussed in further detail below). In some examples, a prominent user can include a user having a number of asymmetric contacts within the one or more computer-implemented services that exceeds a threshold number of asymmetric contacts. By way of example, the author user can include a famous user (e.g., a well-known blogger, a celebrity, a professional athlete, a head of state, etc.) that has a significant number of asymmetric contacts (e.g., followers) within one or more social networking services. In such an example, and as discussed in further detail below, the prominent user can be described as a followee user and the asymmetric contacts can each be described as a follower user (e.g., a follower user follows a followee user within the one or more computer-implemented services).

In some implementations, a user can be determined to be a prominent user based on connections that the user has, the number of resources distributed and the amount of traffic generated by the user within the one or more computer-implemented services. By way of example, a social networking service can be considered. In some examples, a number of relationships that the user has within the social networking service can be determined. In some examples, the relationships can include asymmetric relationships, in which the user is a followee user with respect to a plurality of follower users. In some examples, the relationships can include symmetric relationships. In some examples, the relationships can include one degree of separation between the user and other users of the social networking service. In some examples, the relationships can include one degree of separation between the user and other users of the social networking service. In some examples, if the number of relationships exceeds a threshold number of relationships, the user can be determined to be a prominent user. In some examples, if the number of documents distributed by the user exceeds a threshold number of documents, the user can be determined to be a prominent user. In some examples, if a traffic value associated with the user exceeds a threshold traffic value, the user can be determined to be a prominent user. In some implementations, if one or more of the above-described example criteria are not met, the user is not determined to be a prominent user. As discussed in further detail below, categorization of users as prominent users can affect author-based query restricts that are included in an augmented query. Resources that are authored by the user and that are distributed through the social networking service can have an author-based document restrict associated therewith (e.g., <authored by X>, where X is an identifier associated with the user). In some examples, resources that are authored by the user and that are distributed through the social networking service can have one or more user-based document restricts associated therewith (e.g., <show to Q>, <show to R>, <show to S>, where Q, R, S are identifiers associated with users to which the resource is distributed within the social networking service).

One or more query restricts can be associated with a user of the social networking service. In some examples, the one or more query restricts can be determined based on the relationships the user has with other users of the social networking service. In some examples, a query restrict can include a user-based query restrict. An example user-based query restrict can include <show to Q>, where Q is an identifier associated with the user. In some examples, query restricts can include author-based query restricts. Example author-based query restricts can include <authored by X>, <authored by Y>, <authored by Z>, where X, Y, Z are identifiers associated with the prominent users that the user follows. In some implementations, one or more author-based query restricts are identified based on respective prominent users that the user follows within the social networking service. In some examples, an author-based query restrict corresponding to a prominent user that the user follows is included in the augmented query.

In some implementations, the number of author-based query restricts associated with the user can be limited to a threshold number of author-based query restricts. In some examples, the threshold number of author-based query restricts is based on a number of nodes that can be used to append query restricts to an original query to provide an augmented query. In some examples, the number of nodes can be limited to avoid degraded performance (e.g., latency) in providing search results responsive to the augmented query. By way of example, the user can be a follower user with respect to m prominent users (e.g., followee users, with respect to the user), and the threshold number of author-based query restricts (r) can be less than m. Consequently, author-based query restricts cannot be included for all of the m prominent users that the user follows.

In some implementations, a subset of the m prominent users can be selected, where the subset includes r prominent users. In some examples, prominent users that are included in the subset of prominent users can be determined based on one or more scores associated with the prominent users. In some examples, prominent users that the user follows can be put in rank order based on scores (e.g., in descending order) and the top r prominent users can be selected to populate the subset of prominent users. In some examples, prominent users that are included in the subset of prominent users can be determined based on user input. In some examples, user input can include explicit user selection of prominent users to include in the subset of prominent user and/or an indication that prominent users are to be selected based on the one or more scores. Author-based query restricts can be generated for each of the prominent users in the subset of prominent users, and can be associated with the user.

By way of example, a user-specific affinity score can be associated with each prominent user in the set of m prominent users. Each user-specific affinity score can reflect a relative strength of the relationship between the user and a respective prominent user. For example, if the user often interacts with content distributed by a first prominent user, a first affinity score between the user and the first prominent user can be associated with a first value. If the user interacts with content distributed by a second prominent user less often, a second affinity score between the user and the second prominent user can be associated with a second value, e.g., where the first value is greater than the second value. By way of another example, a prominence score can be associated with each prominent user in the set of m prominent users. Each prominence score can reflect a relative prominence of a respective prominent user within one or more computer-implemented services. For example, if a first prominent user often distributes content and/or other users often interact with the distributed content, a first prominence score associated with the first prominent user can include a first value. If a second prominent user less often distributes content and/or other users less often interact with the distributed content, a second prominence score associated with the second prominent user can include a second value, e.g., where the first value is greater than the second value. In some examples, combinations of scores can be provided.

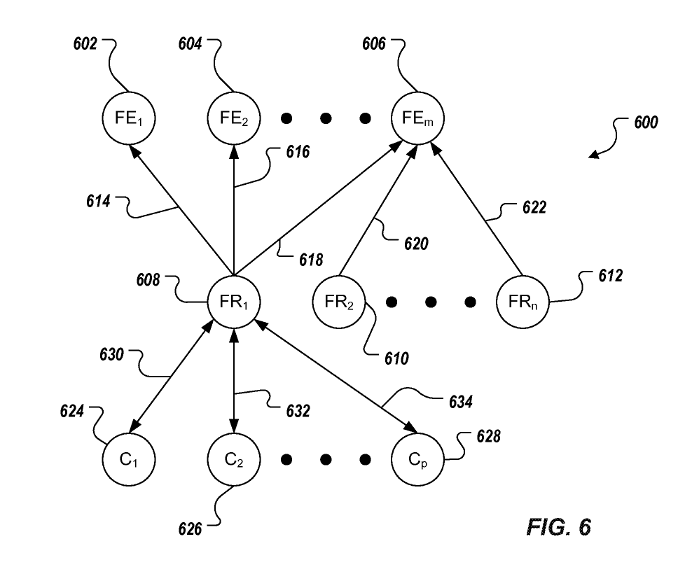

FIG. 6 depicts an example social graph portion 600. The social graph portion 600 includes nodes 602, 604, . . . , 606 representing followee users FE₁, FE₂, . . . , FEₘ, respectively. In the depicted example, each of the followee users FE₁, FE₂, . . . , FEₘ can be prominent users. The social graph portion 600 includes nodes 608, 610, . . . , 612 representing follower users FR₁, FR₂, . . . , FRₙ, respectively. In the depicted example, edges 614, 616, . . . , 618 represent the asymmetric relationship between the follower user FR₁ and each of the followee users FE₁, FE₂, . . . , FEₘ, respectively, in one or more computer-implemented services. Edges 620, 622 represent the asymmetric relationship between the follower users FR₂, . . . , FRₙ and the followee users FE₂, . . . , FEₘ, respectively, in one or more computer-implemented services. The social graph portion 600 further includes nodes 624, 626, . . . , 628 respectively representing contacts C₁, C₂, . . . , Cₚ of the follower user FR₁ in one or more computer-implemented services. In the depicted example, edges 630, 632, . . . , 634 represent the symmetric relationship between the follower user FR₁ and each of the contacts C₁, C₂, . . . , Cₚ, respectively. In some examples, each edge 614, 616, 618, 620, 622 can be associated with one or more scores. In some examples, the one or more scores can include affinity scores and/or prominence scores, discussed in detail above.

In accordance with implementations of the present disclosure, one or more query restricts can be generated and can be associated with each user of the one or more computer-implemented services (e.g., the followee users FE₁, FE₂, . . . , FEₘ, follower users FR₁, FR₂, . . . , FRₙ, and the contacts C₁, C₂, . . . , Cₚ). For purposes of illustrating the one or more query restricts, and by way of example, the follower user FR₁ can be considered. Because the follower user FR₁ is a follower of each of the followee users FE₁, FE₂, . . . , FEₘ, and each of the followee users FE₁, FE₂, . . . , FEₘ is a prominent user, respective author-based query restricts can be generated. In some examples, the author-based query restricts can include <authored by FE₁>, <authored by FE₂>, . . . , <authored by FEₘ>, respectively. A user-based query restrict can be generated for the follower user FR₁. In some examples, the user-based query restrict can include <show to FR₁>.

For purposes of illustrating the one or more query restricts, and by way of example, the followee user FE₁ and the contact C₁ can be considered. The followee user FE₁ can publish a resource for public consumption using one or more computer-implemented services. The resource can be indexed and can be associated with an author-based document restrict <authored by FE₁>. The contact C₁ can publish a resource to a private audience that includes the follower user FR₁ using one or more computer-implemented services. The resource can be indexed for and can be associated with a user-based document restrict <show to FR₁>. In some examples, more than one user-based document restrict can be associated with the resource published by the contact C₁ (e.g., in cases where the private audience includes other users in addition to the follower user FR₁).

The follower user FR₁ can submit a search query (e.g., <QUERY>) to a search system (e.g., the search system 114). The search system can retrieve social restricts associated with the follower user FR₁ and can append the social restricts to the query to provide an augmented query. Continuing with the example above, the augmented query can be provided as:
<QUERY> AND [<show to FR₁> OR <authored by FE₁> OR <authored by FE₂> OR . . . OR <authored by FEₘ>]
   In some examples, a first set of search results (e.g., web results) responsive to the original query (e.g., <QUERY>) can be provided and a second set of search results (e.g., social search results) responsive to the augmented query can be provided. The first set of search results and the second set of search results can be displayed to the follower user FR₁.

Implementations of the present disclosure and all of the functional operations described in this specification can be realized in digital electronic circuitry, or in computer software, firmware, or hardware, including the structures disclosed in this specification and their structural equivalents, or in combinations of one or more of them. Implementations of the present disclosure can be realized as one or more computer program products, e.g., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the present disclosure can be realized on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the present disclosure can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the present disclosure, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the present disclosure or of what may be claimed, but rather as descriptions of features specific to particular implementations of the present disclosure. Certain features that are described in this specification in the context of separate implementations can also be implemented in combination in a single implementation. Conversely, various features that are described in the context of a single implementation can also be realized in multiple implementations separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results.

1. A computer-implemented method executed by one or more processors, the method comprising:
receiving a query from a user;
identifying, by the one or more processors, social graph information associated with the user, the social graph information including i) first information regarding one or more author-users the user has an asymmetric relationship with through one or more computer-implemented social networking services and ii) second information regarding one or more contacts the user has a symmetric relationship with through the one or more computer-implemented social networking services;
determining that a number of the one or more author-users the user has the asymmetric relationship with through the one or more computer-implemented social networks is greater than a threshold;
in response to the determining, limiting the number of the one or more author-users the user has the asymmetric relationship with through the one or more computer-implemented social networks to a threshold number of the one or more author users based on one or more performance parameters associated with providing social search results based on the query;
generating, by the one or more processors, one or more social query restricts associated with the user, the one or more social query restricts comprising i) a set of author-based query restricts based on the first information and the threshold number of the one or more author restricts and ii) a set of user-based query restricts based on the second information;
generating an augmented query based on the query and the one or more social query restricts;
obtaining a set of social search results that are responsive to the augmented query, each social search result in a first sub-set of the set of social search results being associated with an author-based document restrict that corresponds to an author-based query restrict in the set of author-based query restricts, each social search result in a second sub-set of the set of social search results being associated with an user-based document restrict that corresponds to a user-based query restrict in the set of user-based query restricts; and
providing the social search results for display to the user.

2. The method of claim 1, wherein the one or more author-users includes one or more prominent users.

3. The method of claim 1, wherein the one or more author-users includes a plurality of prominent users, and wherein limiting the number of the one or more author-users the user has the asymmetric relationship with through the one or more computer-implemented social networks includes:
selecting a set of prominent users from the plurality of prominent users based on one or more performance parameters associated with providing social search results based on the query.

4. The method of claim 3, wherein selecting a set of prominent users from the plurality of prominent users comprises receiving a plurality of scores, each score being associated with a respective prominent user in the plurality of prominent users, each prominent user in the set of prominent users being selected for inclusion in the set of prominent users based on the score.

5. The method of claim 4, wherein the score comprises a prominence score that reflects a relative prominence of a respective prominent user within the one or more computer-implemented services.

6. The method of claim 4, wherein the score is based on a number of followers of the respective prominent user within the one or more computer-implemented services.

7-8. (canceled)

9. The method of claim 2, wherein at least one prominent user of the plurality of prominent users published a resource using the one or more computer-implemented services, the resource being associated with a social search result in the social search results.

10. The method of claim 1, further comprises determining that the one or more author-users have at least a threshold number of relationships with other users in the one or more computer-implemented services.

11. Computer storage media encoded with one or more computer programs, the one or more computer programs comprising instructions that when executed by data processing apparatus cause the data processing apparatus to perform operations comprising:
receiving a query from a user;
identifying social graph information associated with the user, the social graph information including i) first information regarding one or more author-users the user has an asymmetric relationship with through one or more computer-implemented social networking services and ii) second information regarding one or more contacts the user has a symmetric relationship with through the one or more computer-implemented social networking services;
determining that a number of the one or more author-users the user has the asymmetric relationship with through the one or more computer-implemented social networks is greater than a threshold;
in response to the determining, limiting the number of the one or more author-users the user has the asymmetric relationship with through the one or more computer-implemented social networks to a threshold number of the one or more author users based on one or more performance parameters associated with providing social search results based on the query;
generating one or more social query restricts associated with the user, the one or more query social restricts comprising i) a set of author-based query restricts based on the first information and the threshold number subset of the one or more author restricts and ii) a set of user-based query restricts based on the second information;
generating an augmented query based on the query and the one or more social query restricts;
obtaining a set of social search results that are responsive to the augmented query, each social search result in a first sub-set of the set of social search results being associated with an author-based document restrict that corresponds to an author-based query restrict in the set of author-based query restricts, each social search result in a second sub-set of the set of social search results being associated with an user-based document restrict that corresponds to a user-based query restrict in the set of user-based query restricts; and
providing the social search results for display to the user.

12. The computer storage media of claim 11, wherein the one or more author-users includes one or more prominent users.

13. The computer storage media of claim 11, wherein the one or more author-users includes a plurality of prominent users, and wherein limiting the number of the one or more author-users the user has the asymmetric relationship with through the one or more computer-implemented social networks includes:
selecting a set of prominent users from the plurality of prominent users based on one or more performance parameters associated with providing social search results based on the query.

14. The computer storage media of claim 13, wherein selecting a set of prominent users from the plurality of prominent users comprises receiving a plurality of scores, each score being associated with a respective prominent user in the plurality of prominent users, each prominent user in the set of prominent users being selected for inclusion in the set of prominent users based on the score.

15. The computer storage media of claim 14, wherein the score comprises a prominence score that reflects a relative prominence of a respective prominent user within the one or more computer-implemented services.

16. The computer storage media of claim 14, wherein the score is based on a number of followers of the respective prominent user within the one or more computer-implemented services.

17.-18. (canceled)

19. The computer storage media of claim 12, wherein at least one prominent user of the plurality of prominent users published a resource using the one or more computer-implemented services, the resource being associated with a social search result in the social search results.

20. The computer storage media of claim 11, further comprises determining that the one or more author-users have at least a threshold number of relationships with other users in the one or more computer-implemented services.

21. A system comprising:
a computing device; and
a computer-readable medium coupled to the computing device and having instructions stored thereon which, when executed by the computing device, cause the computing device to perform operations comprising:
receiving a query from a user;
identifying social graph information associated with the user, the social graph information including i) first information regarding one or more author-users the user has an asymmetric relationship with through one or more computer-implemented social networking services and ii) second information regarding one or more contacts the user has a symmetric relationship with through the one or more computer-implemented social networking services;
determining that a number of the one or more author-users the user has the asymmetric relationship with through the one or more computer-implemented social networks is greater than a threshold;
in response to the determining, limiting the number of the one or more author-users the user has the asymmetric relationship with through the one or more computer-implemented social networks to a threshold number of the one or more author users based on one or more performance parameters associated with providing social search results based on the query;
generating one or more social query restricts associated with the user, the one or more query social restricts comprising i) a set of author-based query restricts based on the first information and the threshold number of the one or more author restricts and ii) a set of user-based query restricts based on the second information;
generating an augmented query based on the query and the one or more social query restricts;
obtaining a set of social search results that are responsive to the augmented query, each social search result in a first sub-set of the set of social search results being associated with an author-based document restrict that corresponds to an author-based query restrict in the set of author-based query restricts, each social search result in a second sub-set of the set of social search results being associated with an user-based document restrict that corresponds to a user-based query restrict in the set of user-based query restricts; and
providing the social search results for display to the user.

22. The system of claim 21, wherein the one or more author-users includes one or more prominent users.

23. The system of claim 21, wherein the one or more author-users includes a plurality of prominent users, and wherein limiting the number of the one or more author-users the user has the asymmetric relationship with through the one or more computer-implemented social networks includes:
selecting a set of prominent users from the plurality of users based on one or more performance parameters associated with providing social search results based on the query.

24. The system of claim 23, wherein selecting a set of prominent users from the plurality of prominent users comprises receiving a plurality of scores, each score being associated with a respective prominent user in the plurality of prominent users, each prominent user in the set of prominent users being selected for inclusion in the set of prominent users based on the score.

25. The system of claim 24, wherein the score comprises a prominence score that reflects a relative prominence of a respective prominent user within the one or more computer-implemented services.

26. The system of claim 24, wherein the score is based on a number of followers of the respective prominent user within the one or more computer-implemented services.

27-28. (canceled)

29. The system of claim 22, wherein at least one prominent user of the plurality of prominent users published a resource using the one or more computer-implemented services, the resource being associated with a social search result in the social search results.

30. The system of claim 21, further comprises determining that the one or more author-users have at least a threshold number of relationships with other users in the one or more computer-implemented services.
